(19) United States
(12) Patent Application Publication
(10) Pub. No.: US 2004/0074125 A1
(43) Pub. Date: Apr. 22, 2004

(54) Iron-wood golf club head accessory

(76) Inventor: Patrick G. Johnson, San Diego, CA (US)

Correspondence Address: Mo Savari, Esq., 8328 Regents Road#3H, San Diego, CA, 92122, US

(21) Appl. No.: 10/272,887

(22) Filed: Oct. 17, 2002

(51) Int. Cl. G09F 3/10

(52) U.S. Cl. 40/638; 40/915

(57) ABSTRACT

The Iron-Wood Golf Club Head Accessory of the present invention provides many advantages to a golfer. A beginner or intermediate golfer will benefit from the instructions printed on the piece of material that is attached to the club head. Also, a golfer can write instructions or notes on a clear piece of material that is attached to the club-head. Adding an advertising medium on the top of the club head gives companies another avenue to expose their products or services. In addition, artwork can be place on the material and attached to the golf club head, which will give golfers comfort or add personality to their clubs. Finally, the material attached to the golf club head will protect the paint from being scratched or dinged.

### FIELD OF THE INVENTION

The present invention relates generally to golf club accessories. More specifically, the present invention pertains to pieces of material that can be attached on the top portion of a wood golf club head. The present invention is particularly, though not exclusively, useful as a means for providing golf instructions, advertisements, and artwork on the top portion of a wood golf club head that can be attached and removed without leaving a residue on the club.

### BACKGROUND OF THE INVENTION

Golf is a popular sport around the world. In the United States, there are over 12,000 golf courses and thousands more driving ranges. Golf equipment accessories make up a multi-billion dollar market that is composed of large companies and corporations. Tens of millions of people play golf in the United States and many more millions play throughout the world. The success of this market is centered upon innovations in product development or marketing and advertisement.

Learning to play golf is a difficult and time-consuming endeavor. A person must go through many stages to get to a decent handicap. The process starts by selecting equipment that best fits the golfer. The first set of equipment purchased is a set of golf clubs, which should suite the golfer's height, weight, build, and multiple other characteristics. A typical set of golf clubs includes fourteen (14) clubs: 1-wood, 3-wood, 5-wood, 3-iron through 9-iron, pitching wedge, sand wedge, gap wedge or loft wedge, and putter. Traditionally, wood clubs have the longest shafts and largest club heads that were actually composed of various types of wood. As technology improved over a century later, wood golf club heads were made of various metals. One of the first metals used was iron, but because iron is a very heavy metal it was replaced by aluminum. Technically, clubs that have metal club heads and are in the shape of older wood club heads are still called iron-wood golf clubs, even though they do not contain any iron in them. Iron-wood golf clubs are the standard for performance in today's golf era.

Once suitable clubs are selected, a person usually goes to a driving range where he/she can practice swinging the clubs and hitting balls. At this point, a coach/instructor is usually very helpful in demonstrating correct techniques. Most beginner golfers have similar problems, such as lifting their head too soon, not shifting their weight properly during the backswing, and not following through after they hit the ball. It is not unusual to see a coach/instructor constantly telling a player to focus on the ball or instruct as to other corrections needed. Having a coach/instructor is expensive and most of the time the coach/instructor is giving the golfer the same instruction over and over. It would be cheaper and more efficient if a device was created that would remind the golfer to keep his/her head down or give other instructions as needed. Advertising is also a major component of modern golf. Various golf product manufacturers advertise on golf bags, tees, golf balls, towels, hats, gloves, and many other golf-related products. U.S. Pat. No. 6,367,181 (Patent '181) issued to Skoog on Apr. 9, 2002, for an invention entitled “Golf Ad,” discloses a golf cart display apparatus. Patent '181 provides a rigid transparent material where graphical golf course maintenance reminders can be placed on a golf cart. Patent '181 illustrates the benefit of creating new types of advertising apparatus. However, Patent '181 does not apply to the golf club itself.

Many different mediums are used to display artwork. Along with the numerous types of mediums, many more purposes exist. Artwork can be used to relax, excite, cause sadness and happiness in a person. Golf is an activity that is usually very relaxing, however, not playing well can cause frustration. A series of artwork that creates relaxation in frustrating situations is not currently available for a golfer.

The cost of new iron-wood golf clubs can range from $100 for a generic to $500 for a top-of-the-line model. Depending on the model, the top portion of the club head is painted with high quality paint because this portion is visible to the golfer and observers. The color of paint varies from club to club but the high quality paint on this portion remains constant. Dings or scratches can ruin the paint or finish on the top portion of the golf club by common use. However, there is currently no accessories that can protect the painted top portion of the iron-wood golf club head.

Accordingly, it is one object of the present invention to provide an iron-wood golf club head accessory that gives instructions to a golfer and can be attached and removed without leaving a residue on the club head.

It is another object of the present invention to provide an iron-wood golf club head accessory that has a substantially blanks area where the golfer can write reminders and can be attached and removed without leaving a residue on the club head.

It is an additional object of the present invention to provide an iron-wood golf club head accessory that has advertisements and can be attached and removed from the club head without leaving a reside.

It is yet another object of the present invention to provide an iron-wood golf club head accessory that includes artwork and can be attached and removed from the club head without leaving a residue.

It is another object of the present invention to provide an iron-wood golf club head accessory that can be attached to protect the clubhead and removed from the top portion of the club head without leaving a residue.

### SUMMARY OF THE PRESENT INVENTION

The Iron-Wood Golf Club Head Accessory of the present invention is a substantially flat and flexible material that is attached to the top portion of a iron-wood golf club head and provides several benefits to a golfer. The benefits gained are in the form of instructions, advertisements, and relaxation or motivation initiated by artwork attached to the top of the iron-wood golf club. Due to the varying sizes of iron-wood clubs, specifically the 1-wood through 5-wood, the amount of accessories that one set of golf clubs can accommodate is significantly high. Also, the amount of area that a iron-wood club has on its top surface is greater than any other club.

The first major benefit of the Iron-Wood Golf Club Head Accessory is that it contributes to a golfer's technique by providing specific instruction(s). This is accomplished by having a preprinted instruction on the top surface of the material that comprises the present invention. Creating a unique and personalized set of instructions will allow a golfer to focus on the trouble area(s) so that he/she can correct the problem and play better. For example, a golfer who repeatedly forgets to keep his/her eye on the ball during the, down-swing can have the instructions “EYES ON THE BALL” printed on the top surface of the present invention. Now, every time the golfer approaches and prepares to hit the ball, he/she will see the instruction(s) just before he/she begins the back-swing. Similarly, a coach/instructor will accomplish the same task by verbally reminding the golfer to focus on that area. However, a major difference is that a coach/instructor is expensive, has limited availability, and does not come to a golfer's back yard where he/she likes to practice.

The next major benefit of the Iron-Wood Golf Club Head Accessory is that a golfer can write reminders or notes with a marker on the blank space provided by attaching the present invention to the top of an iron-wood club head. A blank space gives the golfer flexibility in what type of specialized reminders or designs that he/she wants to write. The most effective color for the blank space is white or a shade close to white. This would allow almost any color marker to be used for writing personal instructions on the club head accessory. Preferably, a non-permanent marker should be used so that the golfer can erase the reminder and put another reminder in its place. However, it would also be possible to produce a dark blank space and use a light colored marker. Either color that is used for the blank space will aid in the improvement of playing golf.

The third major benefit of the Iron-Wood Golf Club Head Accessory is that it allows companies to place any type of advertisement on the material and attach it to the top of a iron-wood golf club head. The advantage of advertising on the top of an iron-wood club head extends beyond the golfer using the club to persons watching the golfer, such as other players in the group or observers. Because wood clubs have a large top surface, large advertisements could be utilized and would create a new medium for advertising. In addition, the amount of potential users of this product include almost every golfer in the world. The advertising market is enormous in the United States and world. Therefore, the expected benefits of this new medium of advertisements will stretch beyond traditional advertisements.

The fourth major benefit of the Iron-Wood Golf Club Head Accessory is that artwork could be printed onto the material and attached to the top of the iron-wood club heads. As discussed earlier, artwork has many purposes. One purpose is to relax an observers. It would be greatly advantageous for a nervous or frustrated golfer to look at a relaxing picture or artwork and change the golfers mood. Another purpose that artwork serves is to motivate observers. Popular motivational artwork includes a picture of a mountain with words at the bottom, such as “Success Is Trying More Times Than You Fail.” Motivational artwork like that can be attached to the top of an iron-wood club head. Other pieces of artwork could be theme oriented. For example, patriotic themes are gaining significant use in the form of United States flags mounted on houses, businesses, or stickers on cars. Similarly, it would be easy to print a United States flag or variation on the material and attach it to the top of an iron-wood golf club head.

Another major benefit of the Iron-Wood Golf Club Head Accessory is that it provides a shield of protection by attaching material to the top portion of the iron-wood golf club head. Due to the high quality of paint on this region of a golf club head, the benefit of the present invention is clear. Golfers would be able to maintain the new appearance of their golf club head by eliminating dings and scratches. The type of material that can be used to satisfy the protector varies from different thicknesses of vinyl, paper, cellophane or any other material that can accomplish the task of protection.

The invention as described above overcomes the disadvantages of the current golf club accessories, which include the absence of using the area on the top portion of iron-wood golf club heads. Additionally, the present invention provides a new medium that can allow instruction(s), blank space to write on, advertisements and artwork to be attached to the top portion of iron-wood golf club heads.

### DESCRIPTION OF THE DRAWINGS

The novel features of this invention, as well as the invention itself, both as to its structure and its operation, will be best understood from the accompanying drawings, taken in conjunction with the accompanying description, in which reference characters refer to similar parts, and in which:

FIG. 1 is a top view of an iron-wood golf club featuring the Iron-Wood Golf Club Head Accessory attached to the top of the club head;

FIG. 2 is a top view of the Iron-Wood Golf Club Head Accessory showing its general shape;

FIG. 3 is a side view of the Iron-Wood Golf Club Head Accessory showing the removable adhesive on the underside;

FIG. 4 is a top view of a preferred embodiment of the Iron-Wood Golf Club Head Accessory demonstrating an instruction that can be seen from the point of view of a golfer holding a wood club;

FIG. 5 is a top view of an alternate embodiment of the Iron-Wood Golf Club Head Accessory showing the blank area on the top surface;

FIG. 6 is a top view of a second alternate embodiment of the Iron-Wood Golf Club Head Accessory showing advertisements on the top surface; and

FIG. 7 is a top view of a third alternate embodiment of the Iron-Wood Golf Club Head Accessory featuring artwork on the top surface.

FIG. 8 is a top view of a fourth alternate embodiment of the Iron-Wood Golf Club Head Accessory featuring a protecting shield that attaches to the top surface.

### DETAILED DESCRIPTION

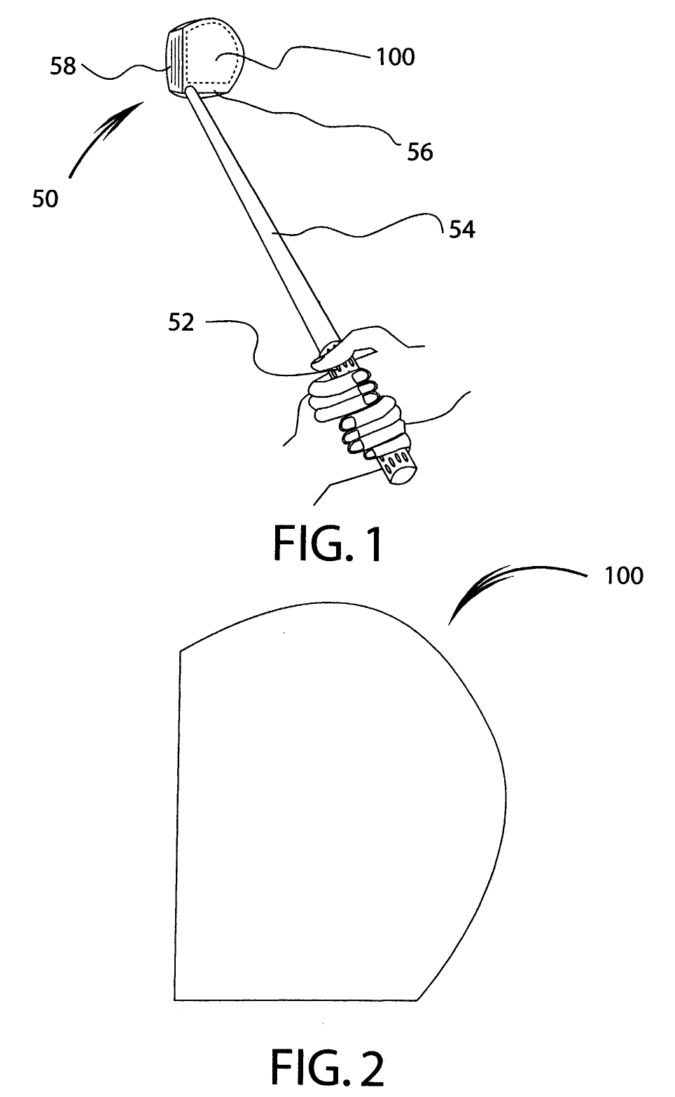

Referring initially to FIG. 1 of the Iron-Wood Golf Club Head Accessory of the present invention, which is shown and generally designated 100. FIG. 1 shows a top view of iron-wood golf club 50 with hand grip 52, shaft 54, club head upper surface 56 and club face 58. It is likely club head upper surface 56 is composed of metal. Iron-Wood Golf Club Head Accessory 100 is substantially flat and flexible and attached to club head upper surface 56.

FIG. 2 is a top view of the Iron-Wood Golf Club Head Accessory 100 showing its general shape. The most common shape is a half oval. However, it should be noted that other shapes can be created depending on the need. The shape and angles of club heads vary, therefore, alternative shapes of the present invention will also need to vary.

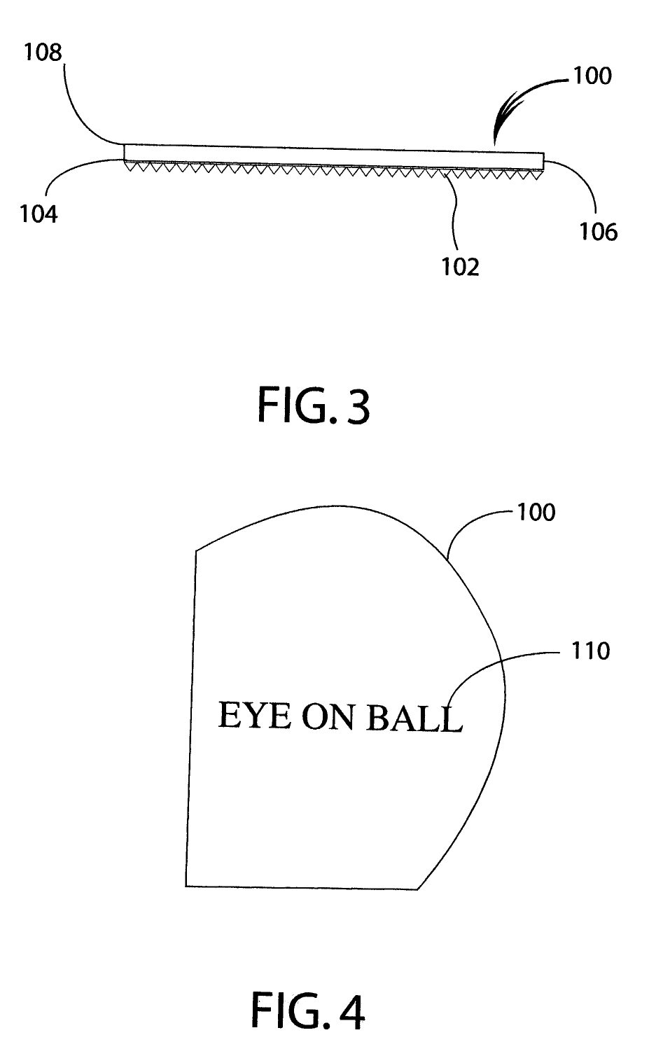

FIG. 3 is a side view of the Iron-Wood Golf Club Head Accessory 100 showing removable adhesive 102 attached to underside 104 of flat and flexible material 106. Flat and flexible material 104 may be composed of a variety of materials, such as vinyl, polymer, paper, cellophane, or other material that is flat, flexible, can be printed on and can have adhesive attached. Flat and flexible material 104 must be capable of having removable adhesive 102 attached to underside 104 and be able to be printed or written on upper surface 108. Removable adhesive 102 is attached to the underside of material 104 in order for flat and flexible material 104 to be attached to club head upper surface 56. Removable adhesive 102 may be composed of a variety of removable adhesives that allow a user to attach, remove, and reattach flat and flexible material 104 to club head upper surface 56, such as a variety of glues, pastes, magnets or any other material that can hold flat and flexible material 104 to upper surface 108. Examples of products that use an adhesive that is similar to removable adhesive 102 are on small vinyl reminders from automotive repair shops that give the date of next oil change and attaches to the windshield. It is also important that removable adhesive 102 not leave a residue on club head upper surface 56 if removed because iron-wood golf clubs are very expensive.

FIG. 4 is a top view of a preferred embodiment of the Iron-Wood Golf Club Head Accessory 100 and demonstrates instruction 110 that can be seen from the point of view of a golfer holding iron-wood golf club 50. Instruction 110 is preprinted on upper surface 108 and can have a variety of instructions. The specific instruction on 110 in the preferred embodiment is “EYES ON BALL.” This instruction is for a golfer who takes his/her eyes off the ball during the down-swing resulting in topping the ball or hitting the grass. The variety of instructions are only limited by the types of problems that golfers have.

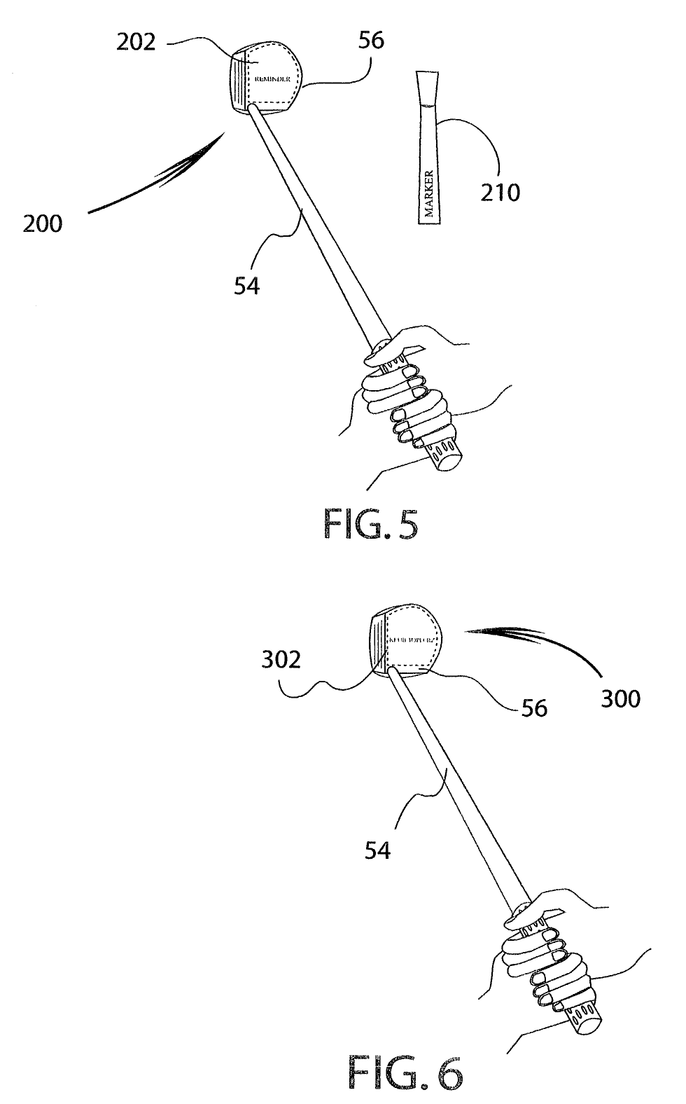

FIG. 5 is a top view of an alternate embodiment of the Iron-Wood Golf Club Head Accessory and is designated 200 and shows blank area 202 on club head upper surface 56 where a golfer can write reminders or notes with marker 210. Blank area 202 will vary in size depending on the size of iron-wood golf club 50. It is important to note that the ink from marker 210 is not permanent and can be erased from blank area 202 as desired by the golfer.

FIG. 6 is a top view of a second alternate embodiment of the Iron-Wood Golf Club Head Accessory and is designated 300 and shows advertisement 302 and is attached to club head upper surface 56. The amount of advertisements that can be used in conjunction with the current embodiment are endless and do not have many, if any, regulations to the use of club head accessories. In this figure, “Klub Topperz™” is shown as an example of an advertisement. Advertisement 302 can also come in the form of designs, pictures, graphics or any other printed form.

FIG. 7 is a top view of a third alternate embodiment of the Iron-Wood Golf Club Head Accessory and is designated 400 and features artwork 402 on club head upper surface 56. Artwork 402 can be in the form of print, paint, etching, or any other tangible form that can fit in the area provided by Iron-Wood Golf Club Head Accessory 400.

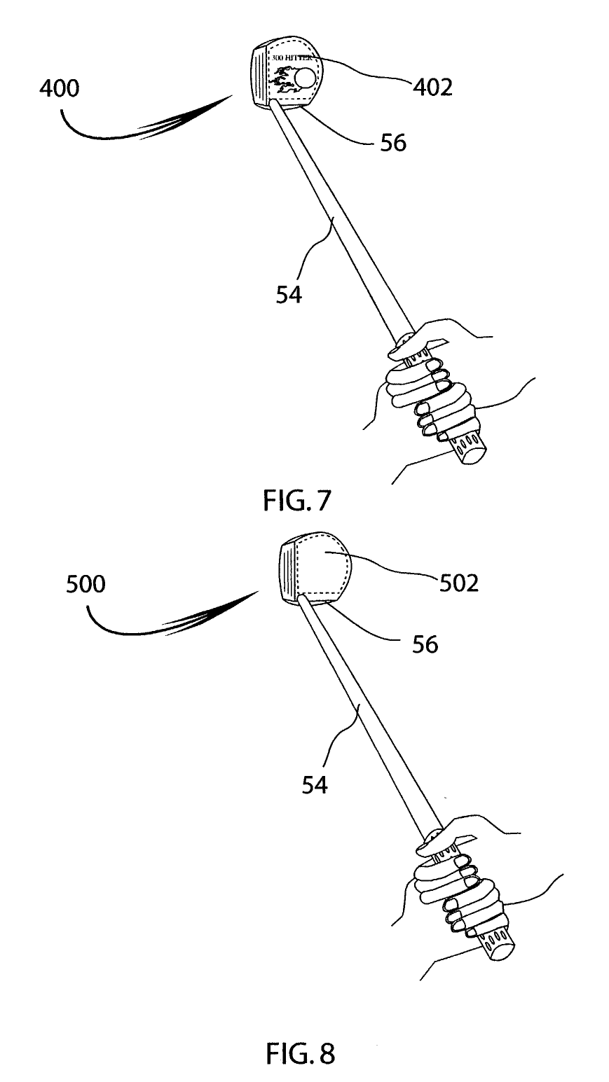

FIG. 8 is a top view of a fourth alternate embodiment of the Iron-Wood Golf Club Head Accessory and is designated 500 and shows protecting shield 502 on club head upper surface 56. It should be noted that protecting shield 502 may be composed of vinyl, paper, cellophane or any other material that is substantially flat, flexible and light in weight. Protecting shield 502 also has adhesive attached to its underside to allow it to be removably attached to the top portion of the club head.

I claim:

1. An iron-wood golf club head accessory comprising:
a substantially flat and flexible material in the shape of the top portion of an iron-wood golf club head; and
means for attaching said substantially flat and flexible material to the top portion of an iron-wood golf club head.
wherein a golfer can manipulate and attach said flexible material on the top surface of an iron-wood golf club head secured by said adhesive.

2. The iron-wood golf club head accessory in claim 1, wherein said substantially flat and flexible material has instructions printed on the top surface so that a golfer in the hitting position can read the instructions.

3. The iron-wood golf club head accessory in claim 1, wherein said substantially flat and flexible material is blank on the top surface so that a golfer can write personalized instructions with a marker or pen.

4. The iron-wood golf club head accessory in claim 1, wherein said substantially flat and flexible material has advertisements printed on the top surface.

5. The iron-wood golf club head accessory in claim 1, wherein said substantially flat and flexible material has artwork printed on the top surface.

6. The iron-wood golf club head accessory in claim 1, wherein said substantially flat and flexible material has designs that promote better golfing technique.

7. The iron-wood golf club head accessory in claim 1, wherein said substantially flat and flexible material serves to protect the club head from scratches and dings.

8. The iron-wood golf club head accessory in claim 1, wherein said means for attaching said substantially flat and flexible material to the top portion of an iron-wood golf club head is an adhesive.

9. The iron-wood golf club head accessory in claim 1, wherein said means for attaching said substantially flat and flexible material to the top portion of an iron-wood golf club head is a magnet.

10. A method for attaching an accessory to an iron-wood golf club head that is likely composed of metals other than iron comprising the steps of:
a. cutting a substantially flat and flexible material in the shape of the top portion of the iron-wood golf club head;
b. placing an adhesive on the bottom portion of said substantially flat and flexible material; and
c. attaching the bottom portion of said substantially flat and flexible material to the top portion of the iron-wood golf club head.

11. The method for attaching an accessory to an iron-wood golf club head in claim 10, wherein said substantially flat and flexible material includes printed instructions on the top surface for a golfer in the hitting position to read.

12. The method for attaching an accessory to an iron-wood golf club head in claim 10, wherein said substantially flat and flexible material includes advertisements on the top surface.

13. The method for attaching an accessory to an iron-wood golf club head in claim 10, wherein said substantially flat and flexible material includes artwork on the top surface.

14. The method for attaching an accessory to an iron-wood golf club head in claim 10, wherein said substantially flat and flexible material includes designs that promote better golf technique.

15. The method for attaching an accessory to an iron-wood golf club head in claim 10, wherein said substantially flat and flexible material serves to protect the golf club head from scratches and dings.

16. The method for attaching an accessory to an iron-wood golf club head in claim 10, wherein said placing an adhesive further comprises adding glue to the adhesive.

17. The method for attaching an accessory to an iron-wood golf club head in claim 10, wherein said placing an adhesive further comprises adding a magnet to the adhesive.

18. An instructional accessory for an iron-wood golf club head comprising:
a substantially flat and flexible material in the shape of the top portion of an iron-wood golf club head;
an adhesive prepared at the bottom side of said substantially flat and flexible material; and
printed instructions on the top surface of said substantially flat and flexible material;
wherein a golfer can manipulate and attached said substantially flat and flexible material on the top surface of an iron-wood golf club head secured by said adhesive.
